(19) United States
(12) Patent Application Publication
(10) Pub. No.: US 2018/0104908 A1
(43) Pub. Date: Apr. 19, 2018

(54) TOOL FOR HF WELDING, SYSTEM FOR WELDING FILMS, SYSTEM FOR PRODUCING A BAG FOR MEDICAL PURPOSES, METHOD FOR OPERATING A SYSTEM AND BAG

(71) Applicant: KIEFEL GMBH, Freilassing (DE)

(72) Inventor: Rudolf Berger, Freilassing (DE)

(21) Appl. No.: 15/782,383

(22) Filed: Oct. 12, 2017

(30) Foreign Application Priority Data
Oct. 18, 2016 (DE) 10 2016 012 428.8
Aug. 24, 2017 (DE) 10 2017 007 964.1

(51) Int. Cl. B29C 65/00; B29C 65/04; B65D 75/30

(52) U.S. Cl. CPC B29C 66/8122; B29C 65/04; B29L 2031/7128; B65D 75/30; B29C 66/8511

(57) ABSTRACT

The invention relates to various aspects of HF-welding methods and HF welding equipment and to a bag produced with an HF-welding method. In tools used for HF welding, it is proposed that the tool is supplemented by an electrically conductive layer, which among other advantages enables the quality of a welded connection, in particular of especially thin films, to be significantly improved.

### CROSS REFERENCE TO RELATED APPLICATIONS

This application claims priority to German application DE 102016012428.8, filed Oct. 18, 2016, and claims priority to German application DE 102017007964.1, filed Aug. 24, 2017, each of which is hereby incorporated by reference in its entirety.

### FIELD OF THE DISCLOSURE

The invention relates to a tool for HF welding, a system for welding films, a system for producing a bag for medical purposes, a method for operating a system, and a bag.

### BACKGROUND OF THE DISCLOSURE

High-frequency welding (HF welding) is a welding technique in which high-frequency electrical energy is introduced into the region of the mating parts, causing the region to be heated up and the mating parts to be welded together.

HF welding processes are often used to weld films together to form an airtight or water-tight bag or hose.

An essential component of the HF welding is the high-frequency heating of the mating parts, or in general, a good.

### SUMMARY

In one aspect, a system for HF-welding of two films includes a welding tool. The welding tool includes a top tool, a lower tool and a weld substrate. The top tool and the lower tool are designed as electrodes. The welding tool includes an electrically conductive layer. The electrically conductive layer is at least partially separated from the lower tool by the weld substrate.

In another aspect, a method of operating a system for HF-welding includes a step of feeding two films into a welding station, wherein the films are fed between a top tool and an electrically conductive layer, and a step of energizing an electrode of the top tool with high-frequency electricity for HF-welding the films.

In yet another aspect, a method of operating a system for HF-welding includes a step of feeding two films into a welding station, wherein the films are fed between a top tool and an electrically conductive layer, a step of energizing an electrode of the top tool with high-frequency electricity for HF-welding the films to form a bag, and a step of filling the bag.

### BRIEF DESCRIPTION OF THE DRAWINGS

FIG. 1 in schematic manner, a tool for HF-welding known from the prior art,

FIG. 2 in schematic manner, an alternative tool for HF-welding known from the prior art,

FIG. 3 in a schematic manner, is a variant of a tool for HF-welding proposed here.

### DETAILED DESCRIPTION

In the high-frequency heating of a substantially planar good which is largely electrically insulating, this good is introduced as a dielectric between two tool jaws—hereinafter referred to as the top tool and lower tool. By applying a high-frequency alternating voltage between the top tool and lower tool, the good is exposed to an alternating electric field, and as a result of dielectric losses is heated up (dielectric heating).

Due to the heating, the mating parts to be welded soften and fuse together in the molten state. When the energy input ends, the mating parts cool, solidify and are now welded together. The resulting weld is very stable. In particular, it may be watertight.

Electrically, the arrangement consisting of the tool jaws and the good constitutes a lossy capacitor, with the good as the dielectric. An input impedance of the arrangement, which can be measured, has a real and an imaginary part. The ratio of the imaginary to the real part, known as the quality factor of the capacitor, is definitive of the dielectric heating capacity of the good: the higher the quality factor, the lower the proportion of the dielectric losses in the good in relation to the power of the alternating field, and the lower the dielectric heating capacity.

The electrical AC voltage across the capacitor is provided by means of a voltage source with a source impedance of 50Ω, for example. A matching network is arranged between the voltage source and the capacitor. The matching network transforms the source impedance of the voltage source into an effective source impedance at the condenser. The electrical power of the AC voltage on the capacitor is converted into a dielectric heating of the good more effectively, the more accurately the effective source impedance matches the complex conjugate of the input impedance.

As well as the good, the matching network also exhibits losses. The smaller the real part of the input impedance of the arrangement, the higher the proportion of the losses in the matching network in relation to the power of the AC voltage provided by means of the voltage source. The thinner the substantially planar good is for a given surface area, the smaller the input impedance, and in particular the smaller its real part: When the goods to be heated are thin, this results in a disadvantageously high proportion of losses in the matching network.

Therefore, a high quality factor—a high imaginary part with a relatively low real part of the input impedance—and a high imaginary part itself, both have a negative effect on the efficiency with which the electrical power of the voltage source can be converted into dielectric heating of the good.

The object of the invention is to provide an improvement on or an alternative to the prior art.

According to a first aspect of the invention, the object is achieved by a tool for HF welding two films, having a top tool, a lower tool and a weld substrate, wherein the top tool and the lower tool are embodied as electrodes, the tool having an electrically conductive layer and said electrically conductive layer being at least partially separated from the lower tool by the weld substrate.

The following explains the use of terms:

It should be pointed out first of all that in the context of the present patent application, indefinite articles and numbers, such as “a/one”, “two”, etc. should be normally understood in the sense of “at least”, hence as “at least one . . . ”, “at least two . . . ”, etc., unless it is explicitly clear from the relevant context or else obvious or technically inevitable to the person skilled in the art, that only “exactly one . . . ”, “exactly two . . . ” etc. can be meant there.

The term “welding” is defined in particular to mean the indissoluble connection of components by the application of heat and/or pressure, with or without welding filler materials.

A “film” designates in particular a thin plastic sheet, either in the form of a single sheet or a continuous tape. In particular, the term “film” is also intended to include PVC film, PU film, EVA-EBA film and EMMA film.

The term “mating part” is understood in particular to mean a film. It is also conceivable, however, for other materials to be used as a mating part.

The term “good” is to be understood as meaning in particular the mating parts to be welded during the HF welding process, in particular films. But specifically, it is also conceivable, for example, that the device for HF welding is used only for HF heating and the “good” is heated up, wherein in that case a “good” shall be understood to mean any kind of material that can be heated by means of a high-frequency procedure.

A “top tool” is understood as meaning a first tool part for HF welding, which as the name suggests, is in particular arranged on top. A top tool can, however, also be arranged below or to the side.

A “lower tool” is understood as meaning a second tool part for HF welding, which as the name suggests, is in particular arranged at the bottom. A lower tool can, however, also be arranged on top or to the side.

Top tool and lower tool interact during operation.

A “weld substrate” is understood as meaning a layer of material, which is located between a welding electrode and at least a portion of a mating part in a designated welding process. In particular, a “weld substrate” is understood as meaning a substantially planar, but in general low-loss, dielectric load of the capacitor, parallel to the good which is to be heated and/or welded. A “weld substrate” can be a separate component, which is connected to another component of the tool. In concrete terms, however, a “weld substrate” can also mean a coating of another component with a different material, in particular a coating of the lower tool, the top tool and/or the electrically conductive layer.

In the prior art, a “weld substrate” in a designated welding process was positioned between an electrode of the tool, in particular the lower tool, and at least a portion of a mating part. Here, it is alternatively proposed that an electrically conductive layer extends between a weld substrate and at least a portion of a mating part.

An “electrode” is an electron conductor, which in cooperation with a counter electrode interacts with a medium located between the two electrodes. Electrodes consist of electrical conductors, in particular made of a metal or graphite.

An “electrically conductive layer” is understood as meaning a material layer that comprises an electrically conductive material. In particular, an electrically conductive layer can comprise a metal or graphite. The “electrically conductive layer” is also called a “central electrode”.

The term “partially” is understood as meaning that at least a part of the surface of the electrically conductive layer, which is oriented in the direction of the lower tool, is not in contact with the lower tool and this part comprises the weld substrate between the electrically conductive layer and the lower tool. It is also conceivable that the entire electrically conductive layer is not in contact with the lower tool and the weld substrate is located between the lower tool and the electrically conductive layer.

In the prior art it has previously been the case that, in order to improve the efficiency of the HF welding process, a weld substrate was used. The weld substrate reduced the capacitance of the capacitor—and thus increased the imaginary part of the input impedance—without substantially changing the real part: The efficiency of the HF welding could therefore be increased by means of the weld substrate.

The capacitance between the top tool and the lower tool is equivalent to a series connection between a first capacitive portion with the weld substrate as the dielectric, and a second capacitive portion with the good to be heated as the dielectric. The thicker the weld substrate, the smaller the first capacitive portion, and the smaller the proportion of the total voltage between the top tool and the lower tool that is available for heating the good: the advantageous reduction of the total capacitance is associated with a reduction of the field strength in the good.

By contrast, it is proposed here that between the weld substrate and the good, a conductive layer is introduced which is electrically insulated against the top tool and lower tool, for example a metal plate. This conductive layer is referred to hereafter as the central electrode. Without loss of generality, for greater clarity of presentation the weld substrate will hereafter be assumed to be placed between the lower tool and central electrode.

The advantage achieved thereby is that the field strength in the good can be increased and the electrical efficiency of the HF tool can be increased, thus reducing energy costs and lessening the impact on the environment.

A further advantage can also be obtained, in that the high mechanical wear known from the prior art, to which the weld substrate is subject and which contributes significantly to the manufacturing costs, is reduced, which means that maintenance costs and the manufacturing costs can be reduced and the availability of the tool and the stability of the production process can be increased.

In the prior art, the mechanical wear stems in the main from two wear mechanisms: the mechanical stress, which leads to a continuous degradation of the weld substrate, and electrical flashovers occurring between the top tool and the lower tool, which generally tend to result in the immediate destruction of the weld substrate. Advantageously, both wear mechanisms can here be dramatically reduced, making the weld quality more reproducible, among other benefits.

A further advantage obtained is that different layer structures of the mating parts in the area of the weld seam are now possible.

Furthermore, the main advantage is obtained by the use of the central electrode, namely that the width of the central electrode in the plane of the substantially planar good can be selected differently from the width of the edge region: a total capacitance between top tool and lower tool is represented by a series connection of a first capacitance between top tool and central electrode, with the good as the dielectric, and a second capacitance between central electrode and lower tool, with the weld substrate as the dielectric.

Taking a different starting point, with a preselected thickness of the weld substrate it is therefore possible to advantageously adjust the proportion of the total voltage between the top tool and the lower tool which is available for dielectric heating of the good, by suitable selection of the width of the central electrode in relation to the width of the edge region.

In particular, by introducing a central electrode in only certain parts of the edge region, this advantageously allows goods with different layer structures in different sections of the edge region to be simultaneously and uniformly welded.

It also advantageously allows an increased thickness, and thus higher mechanical stability, of the weld substrate without the disadvantage of drastically reducing the proportion of the voltage between the top tool and the lower tool which is devoted to the dielectric heating of the good.

The design allows an optimized function of the electrical switchgear, thus enabling the power regulation when lowering the tool into the material to be improved, and field distribution problems to be reduced or even resolved.

Thus, with particularly thin mating parts and/or mating parts with a low loss factor, the further advantage can be obtained that the liability to flashover of the tool is reduced, and both the quality of the weld seam and the reproducibility of the weld seam quality can be improved. For example, the symmetry of the weld can also be improved, because among other things the plane parallelism of the contacting surfaces of the mating parts can be improved, thus increasing the quality of the welded joint.

In concrete terms it is also conceivable, among other advantages, that the electrically conductive layer has a less strongly adhesive surface, enabling the mating part to be more easily released from the tool after the welding process and thus also facilitating shorter cycle times for a weld.

The tool in particular allows the production of urine bags, breast prostheses and catheter packaging with thinner mating parts, in particular films, and at the same time more stable welds with higher welding quality, so that the products can be improved significantly overall.

It is also proposed that the power of the tool automatically regulates itself while the tool is being lowered into the mating parts, so that the probability of occurrence of an electrical flashover is significantly reduced or can be eliminated altogether, enabling the quality of the weld to be improved.

The weld substrate preferably comprises an electrical insulator.

The following explains the use of this term:

An “electrical insulator” has a negligibly low electrical conductivity. It has an extremely high specific resistance and a high dielectric strength.

In concrete terms, it is conceivable for example that the electrically conductive coating comprises a ceramic coating and/or an enamel, and that this additional electrically insulating layer to the electrically conductive layer represents the weld substrate.

Advantageously, it is then possible to simplify the design of the tool.

It is also possible to design the weld substrate to be more wear-resistant and harder. The hardness of the weld substrate can advantageously affect the reproducibility and the quality of the weld seam, because the design of the tool is less elastic, which means among other things that the parallelism of the tool structure and the mating parts is guaranteed even during the welding process. Overall, the costs can thus be reduced and the quality of the welding improved.

A further advantage is obtained from the better capability for releasing the mating parts from the weld substrate.

The welding surface is optionally thermally conductive.

The following explains the use of this term:

The term “thermally conductive” is understood as meaning that the weld substrate exhibits a thermal conductivity.

In concrete terms then, it is conceivable that among other things the lower thermal conductivity of the electrically conductive layer, which can have a positive effect, is compensated by a higher thermal conductivity of the weld substrate.

Advantageously, because the heat dissipation through the weld substrate is facilitated in relation to the cycle rate of the tool with which welding operations are performed, this means it is possible to prevent a fire starting in a mating part as a result of an excessive tool temperature.

The weld substrate preferably comprises an aramid fibre.

This means that it is advantageously possible for the weld substrate to exploit the positive properties of an aramid fibre, thus enabling a heat-resistant, resilient and dimensionally stable weld substrate with very high tensile strength to be produced.

Optionally, the weld substrate can also comprise polyester.

Concretely, it is conceivable that, for example, a polyester is used as a matrix resin for the weld substrate.

It is therefore advantageously possible that the weld substrate can exploit the positive properties of a polyester, in particular the weakly conducting electrical property of the polyester.

The weld substrate preferably comprises polyethylene.

This means it is advantageously possible for the weld substrate to exploit the positive properties of a polyethylene, in particular the good electrical insulating properties of the polyethylene.

Optionally, the weld substrate comprises a hard paper.

The following explains the use of this term:

a “hard paper” is a fibre composite material made of paper and a synthetic resin.

Hard paper is used as an insulator and an insulating carrier material.

This means it is advantageously possible for the weld substrate to exploit the positive properties of a hard paper, in particular the good electrical insulating properties of the hard paper.

The electrically conductive layer is preferably made of metal.

In concrete terms, it is thus conceivable that the electrically conductive layer consists at least partially of stainless steel.

Advantageously, it is then possible for the electrically conductive layer to assume the properties of a metal, in particular the high electrical conductivity of the metal.

The electrically conductive layer is optionally self-adhesive.

The following explains the use of this term:

the term “self-adhesive” is understood to mean that the electrically conductive layer comprises an adhesive layer.

It is thus conceivable that the electrically conductive layer can be glued to the weld substrate and/or the lower tool by means of the adhesive layer.

It is therefore advantageously possible for the electrically conductive layer to be simply and robustly connected to the weld substrate and/or the lower tool so that it cannot slip.

The electrically conductive layer is preferably connected to the weld substrate.

Advantageously, this means that the electrically conductive layer does not need to be positioned in the tool separately from the weld substrate.

The electrically conductive layer is optionally glued to the weld substrate.

It is thus advantageously possible for the electrically conductive layer to be connected to the weld substrate, so that positioning errors can no longer occur between the weld substrate and the electrically conductive layer.

The top tool preferably comprises a separating edge.

The following explains the use of this term:

A “separating edge” is understood to mean an edge-shaped projection and/or an edge-shaped elevation of the top tool.

It is conceivable that the lower tool has a separating edge.

It is often the case that a substantially planar good is only intended to be dielectrically heated in individual areas, an example of which is the HF welding of bags made of two layers of plastic film. The good is heated only in the boundary region of what will later become the bag, and with the simultaneous application of mechanical pressure both layers of film are welded together. For this purpose, for example the lower tool can be designed flat while the top tool has an embossed separating edge in the edge area of the bag or bags to be welded. Electric field strength, dielectric heating and mechanical force are advantageously concentrated in this edge region. The surface area, to which the capacity of the lossy capacitor is proportional, is then no longer defined by the total area of the top tool, but substantially only by the lesser area of the edge region of the bag or bags, as the product of a mean length and a mean width of one or a plurality of such edge regions.

Advantageously, this enables a thin welding line to be produced with a separating edge on the top tool, which has a high weld quality and enables a very robust welding of the mating parts.

Optionally, the weld substrate is arranged between the lower tool and the top tool.

Advantageously, due to the arrangement of the components of the welding tool, it is thus possible to achieve a particularly favourable result.

It is preferable to connect the weld substrate to the lower tool.

This means it is advantageously possible for the weld substrate to be connected to the lower tool, and it does not have to be separately positioned in the tool. This allows the number of welds that can be implemented per unit time to be increased, while the quality of the welding can be increased in equal measure.

Optionally, the electrically conductive layer comprises an electrical connection to the electrical switchgear.

This enables the electrically conductive layer advantageously to be separately supplied with electrical energy.

According to a second aspect of the invention the object is achieved by a system for welding films having a film feeder and a welding station, wherein the welding station comprises a tool according to the first aspect of the invention.

The following explains the use of these terms:

a “film feeder” is understood to mean a device with which the film can be fed to the system for welding films.

A “welding station” is understood to mean a device integrated into the system for welding film, which is equipped with an HF welding tool.

It goes without saying that the advantages of a tool for HF welding of two films according to the first aspect of the invention, having a top tool, a lower tool and a weld substrate, wherein the top tool and the lower tool are embodied as electrodes, the tool having an electrically conductive layer and said electrically conductive layer being at least partially separated from the lower tool by the weld substrate, as described above, extend directly to a system for welding films having a film feeder and a welding station, wherein the welding station comprises a tool according to the first aspect of the invention.

It is explicitly pointed out that the subject matter of the second aspect can be advantageously combined with the subject matter of the above aspect of the invention, both individually or cumulatively in any desired combination.

According to a third aspect of the invention, the object is achieved by a system for producing a bag for medical purposes, having a film feeder, a welding station and preferably a filling station, wherein the welding station comprises a tool according to the first aspect of the invention.

The following explains the use of these terms:

A “bag” is defined as a hollow, thin-walled, easily deformable object, which is suitable for holding other objects, in particular liquids. A bag can be an open or a closed bag.

A “filling Station” means a device used for filling a bag with a medium.

It goes without saying that the advantages of a tool for HF welding of two films according to the first aspect of the invention, having a top tool, a lower tool and a weld substrate, wherein the top tool and the lower tool are embodied as electrodes, the tool having an electrically conductive layer and said electrically conductive layer being at least partially separated from the lower tool by the weld substrate, as described above, extend directly to a system for producing a bag for medical purposes, having a film feeder, a welding station and preferably a filling station, wherein the welding station comprises a tool according to the first aspect of the invention.

It is explicitly pointed out that the subject matter of the third aspect can be advantageously combined with the subject matter of the above aspects of the invention, both individually or cumulatively in any desired combination.

According to a fourth aspect of the invention the object is achieved by a method for operating a system according to the second or the third aspect of the invention, having the steps: feeding two films into the welding station, wherein the films are fed between the top tool and the electrically conductive layer; and energizing the electrodes with high frequency electricity for HF welding the films.

This means it is advantageously possible to carry out a welding of a film in particular to a bag within a system according to the second or the third aspect of the invention and therefore the advantages of a system according to the second or the third aspect of the invention as described above extend directly to a method for operating such a system.

It is explicitly pointed out that the subject matter of the fourth aspect can be advantageously combined with the subject matter of the above aspects of the invention, both individually or cumulatively in any desired combination.

According to a fifth aspect of the invention, the object is achieved by a method for operating a system according to the third aspect of the invention, having the steps: feeding two films into the welding station, wherein the films are fed between the top tool and the electrically conductive layer; energizing the electrodes with high frequency electricity for HF welding the films to a bag; and filling the bag.

This means it is advantageously possible to carry out a welding of a film in particular to a bag within a system according to the third aspect of the invention and therefore the advantages of a system according to the third aspect of the invention as described above extend directly to a method for operating such a system.

It is explicitly pointed out that the subject matter of the fifth aspect can be advantageously combined with the subject matter of the above aspects of the invention, both individually or cumulatively in any desired combination.

According to a sixth aspect of the invention, the object is achieved by a bag, in particular a bag for medical purposes, made from two films by means of a system according to the second or the third aspect of the invention and/or by means of a method according to the fourth or fifth aspect of the invention.

It goes without saying that the advantages of a system according to the second or the third aspect of the invention as described above and/or the advantages of a method according to the fourth or the fifth aspect of the invention as described above, extend directly to a bag, in particular a bag for medical purposes, made from two films by means of such a system and/or such a method.

It is explicitly pointed out that the subject matter of the sixth aspect can be advantageously combined with the subject matter of the above aspects of the invention, both individually or cumulatively in any desired combination.

Hereafter, the invention is described in greater detail based on an exemplary embodiment and with reference to the drawings.

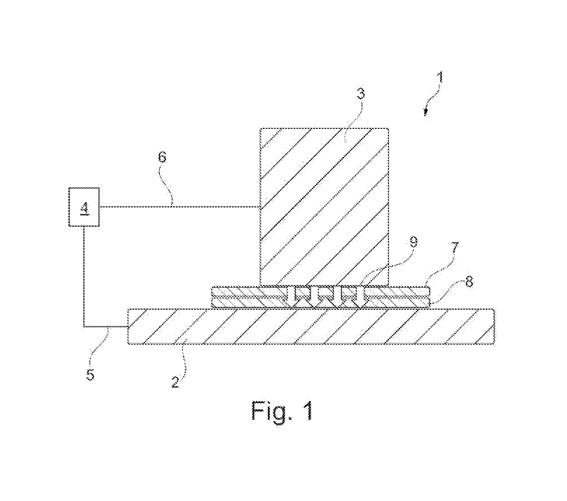

The HF-welding tool (welding tool) 1 belonging to the prior art in FIG. 1 consists substantially of a lower tool 2, a top tool 3 and an electrical switchgear 4, wherein the top tool 3 is mounted above the lower tool 2.

The electrical switchgear 4 is electrically connected to the top tool 3 via the cables 6 and the cable 5 is electrically connected to the lower tool 2.

To weld a first film 7 to a second film 8, these are introduced into the welding tool 1 between the top tool 3 and the lower tool 2 and aligned. Top tool 3 and lower tool 2 are then closed, so that the films 7, 8 can no longer slip in the welding tool 1, and electrical energy (not shown) is transmitted from the electrical switchgear 4 to the top tool 3 and the lower tool 2.

Due to the electrical energy (not shown), an alternating electric field 9 is built up between the top tool 3 and the lower tool 2. The alternating electric field 9 gives rise to a heating (not shown) of the films 7, 8 due to dielectric losses (not shown).

Due to the heating (not shown), the films 7, 8 to be welded soften and join together in the molten state (not shown), also due to the mechanical pressure (not shown) between the top tool 3 and the lower tool 2.

The electrical energy supply (not shown) is then stopped by the electrical switchgear 4. The top tool 3 and the lower tool 2 are then opened and the welded films 7, 8 can be removed.

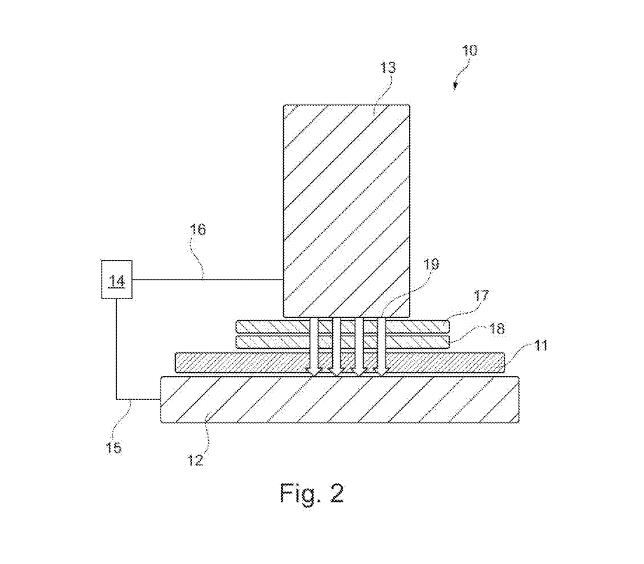

The welding tool 10 belonging to the prior art in FIG. 2 consists substantially of a weld substrate 11, a lower tool 12, a top tool 13 and an electrical switchgear 14, wherein the top tool 13 is mounted above the lower tool 12 and the weld substrate 11 is mounted between the top tool 13 and the lower tool 12.

The electrical switchgear 14 is electrically connected to the top tool 13 via the cables 16 and the cable 15 is electrically connected to the lower tool 12.

The presence of the weld substrate 11 enables an improvement in the efficiency (not shown) of the welding tool 10.

To weld a first film 17 to a second film 18, these are introduced into the welding tool 10 between the top tool 13 and the weld substrate 11 and aligned. Top tool 13 and lower tool 12 are then closed, so that the films 17, 18 can no longer slip in the welding tool 10, and electrical energy (not shown) is transmitted from the electrical switchgear 14 to the top tool 13 and the lower tool 12.

Due to the electrical energy (not shown), an electrical alternating field 19 is built up between the top tool 13 and the lower tool 12. The alternating electric field 19 gives rise to a heating (not shown) of the films 17, 18 due to dielectric losses (not shown).

Due to the heating (not shown), the films 17, 18 to be welded together soften and join together in the molten state (not shown), also due to the mechanical pressure (not shown) between the top tool 13 and the lower tool 12.

The electrical energy supply (not shown) is then stopped by the electrical switchgear 14. The top tool 13 and the lower tool 12 are then opened and the welded films 17, 18 can be removed.

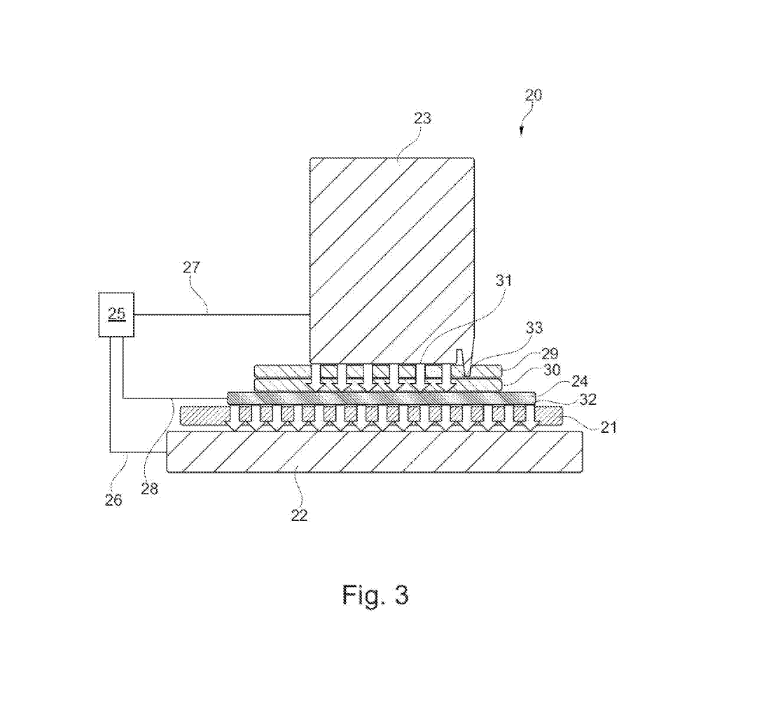

The welding tool 20 in FIG. 3 consists substantially of a weld substrate 21, a lower tool 22, a top tool 23, an electrically conductive layer 24 and an electrical switchgear 25, wherein the top tool 23 is mounted above the lower tool 22, the weld substrate 21 is mounted between the electrically conductive layer 24 and the lower tool 22 and the electrically conductive layer 24 is mounted between the weld substrate 21 and the top tool 23.

The electrical switchgear 25 is electrically connected via the cables 26 to the lower tool 22, and the cable 27 is electrically connected to the top tool 23 and via the cable 28 to the electrically conductive layer 24.

The presence of the welding substrate 21 enables an improvement in the efficiency (not shown) of the welding tool 20.

To weld a first film 29 to a second film 30, these are introduced into the welding tool 20 between the top tool 23 and the electrically conductive layer 24 and aligned. Top tool 3 and lower tool 2 are then closed, so that the films 29, 30 can no longer slip in the welding tool 20, and electrical energy (not shown) is transmitted from the electrical switchgear 25 to the top tool 3, the lower tool 2 and the electrically conductive layer 24.

Due to the electrical energy (not shown), an electrical alternating field 31 is built up between the top tool 23 and the electrically conductive layer 24, and an alternating electric field 32 is built up between the electrically conductive layer 24 and the lower tool 22.

The top tool 23 has a separating edge 33, which causes the electric field strength (not shown) of the alternating field 31, the dielectric heating (not shown) and the mechanical force (not shown), to be advantageously concentrated on to the separating edge 33.

Furthermore, due to the electrically conductive layer 24 the field strength (not shown) of the alternating field 31 in the films 29, 30 is increased, leading to an improvement in the efficiency (not shown) of the welding tool 20.

The alternating electric field 31 gives rise to a heating (not shown) of the films 29, 30 due to dielectric losses (not shown).

Due to the heating (not shown), the films 29, 30 to be welded soften and join together in the molten state (not shown), also due to the mechanical pressure (not shown) between the separating edge 33 of the top tool 23 and the electrically conductive layer 24.

The electrical energy supply (not shown) is then stopped by the electrical switchgear 25. The top tool 23 and the lower tool 22 are then opened and the films 29, 30, welded together in the region of the separating edge 33, can be removed.

### LIST OF REFERENCE NUMERALS USED

1 welding tool
2 lower tool
3 top tool
4 electrical switchgear
5 cable
6 cable
7 film
8 film
9 alternating field
10 welding tool
11 weld substrate
12 lower tool
13 top tool
14 electrical switchgear
15 cable
16 cable
17 film
18 film
19 alternating field
20 welding tool
21 weld substrate
22 lower tool
23 top tool
24 electrically conductive layer
25 electrical switchgear
26 cable
27 cable
28 cable
29 film
30 film
31 alternating field
32 alternating field
33 separating edge

1. A system for HF-welding of two films, the system comprising:
a welding tool comprising:
a top tool, a lower tool and a weld substrate, wherein the top tool and the lower tool are designed as electrodes, and
an electrically conductive layer, the electrically conductive layer being at least partially separated from the lower tool by the weld substrate.

2. The system according to claim 1, wherein the weld substrate comprises an electrical insulator.

3. The system according to claim 1, wherein the weld substrate is thermally conductive.

4. The system according to claim 1, wherein the weld substrate comprises an aramid fibre.

5. The system according to claim 1, wherein the weld substrate comprises polyester.

6. The system according to claim 1, wherein the weld substrate comprises polyethylene.

7. The system according to claim 1, wherein the weld substrate comprises a hard paper.

8. The system according to claim 1, wherein the electrically conductive layer is made of metal.

9. The system according to claim 1, wherein the electrically conductive layer is self-adhesive.

10. The system according to claim 1, wherein the electrically conductive layer is connected to the weld substrate.

11. The system according to claim 1, wherein the electrically conductive layer is glued to the weld substrate.

12. The system according to claim 1, wherein the top tool comprises a separating edge.

13. The system according to claim 1, wherein the weld substrate is arranged between the lower tool and the top tool.

14. The system according to claim 13, wherein the weld substrate is connected to the lower tool.

15. The system according to claim 1, wherein the electrically conductive layer comprises an electrical connection to the electrical switchgear.

16. The system according to claim 1, further comprising a film feeder and a welding station, wherein the welding station comprises ft the welding tool.

17. The system according to claim 1, further comprising a film feeder, a welding station and a filling station, wherein the welding station comprises ft the welding tool.

18. A method for operating the system according to claim 16, having the steps
a. feeding two films into the welding station, wherein the films are fed between the top tool and the electrically conductive layer; and
b. energizing the electrodes with high-frequency electricity for HF-welding the films.

19. A method for operating a system according to claim 17, having the steps
a. feeding two films into the welding station, wherein the films are fed between the top tool and the electrically conductive layer;
b. energizing the electrodes with high-frequency electricity for HF-welding the films to form a bag; and
c. filling the bag.

20. A bag for medical purposes, made from two films using a system according to claim 16.
